(19) United States
(12) Patent Application Publication
(10) Pub. No.: US 2012/0196193 A1
(43) Pub. Date: Aug. 2, 2012

(54) COMPOSITE GRAPHITE PARTICLES AND LITHIUM SECONDARY BATTERY USING THE SAME

(75) Inventors: Chiaki Sotowa, Tokyo (JP); Akinori Sudoh, Tokyo (JP); Masataka Takeuchi, Tokyo (JP); Kyung-hee Han, Anyang-si (KR); Jung-min Han, Anyang-si (KR); Jung-hun Oh, Anyang-si (KR)

(73) Assignees: LS MTRON LTD., Anyang-si, Kyungki-do (KR); SHOWA DENKO K.K., Tokyo (JP)

(21) Appl. No.: 13/254,408

(22) PCT Filed: Mar. 2, 2009
(86) PCT No.: PCT/JP2009/054356

§ 371 Date: Jan. 17, 2012

(51) Int. Cl. H01M 4/583; H01M 10/0569; H01M 10/052; H01M 4/04; H01M 4/64

(52) U.S. Cl. 429/338; 429/231.8; 427/215; 429/211; 429/342

(57) ABSTRACT

The present invention provides composite graphite particles, which are useful for a negative electrode in a secondary battery having high capacitance, good charge-discharge characteristics and good charge-discharge cycle characteristics; and a paste for negative electrode, a negative electrode and a lithium secondary battery which use the composite graphite particles.

The composite graphite particles of the present invention comprises a core material consisting of graphite having a interlayer distance d(002) of 0.337 nm or less in which the intensity ratio I_{D}/I_{G} (R value) between the peak intensity (I_{D}) in a range of 1300 to 1400 cm⁻¹ and the peak intensity (I_{G}) in a range of 1580 to 1620 cm⁻¹ as measured by Raman spectroscopy spectra is from 0.01 to 0.1 and a carbonaceous surface layer in which the intensity ratio I_{D}/I_{G}(R value) between the peak intensity (I_{D}) in a range of 1300 to 1400 cm⁻¹ and the peak intensity (I_{G}) in a range of 1580 to 1620 cm⁻¹ as measured by Raman scattering spectroscopy is 0.2 or higher; wherein the peak intensity ratio I₁₁₀/I₀₀₄ between the peak intensity (I₁₁₀) of face (110) and the peak intensity (I₀₀₄) of face (004) obtained by XRD measurement on the graphite crystal is 0.2 or higher when the particles are mixed with a binder and pressure-molded to a density of 1.55 to 1.65 g/cm³.

### TECHNICAL FIELD

The present invention relates to composite graphite particles and uses thereof. More specifically, it relates to composite graphite particles, which are useful as an active material for negative electrode in a secondary battery having good charge-discharge characteristics and good charge-discharge cycle characteristics; and to a production method thereof; a paste for negative electrode, a negative electrode and a lithium secondary battery which use the composite graphite particles.

### BACKGROUND ART

As power source for portable apparatuses and the like, lithium secondary batteries have been widely used. In the early days after the cellular phones are released, they faced many challenges such as shortage of battery capacitance and a short life of the charge-discharge cycle. Those issues have been resolved one by one and nowadays the lithium secondary battery is expanding the applications from cellular phones, notebook computers, digital cameras, etc. to electric tools, electric bicycles and the like which require more power.

In the future, the use of the lithium secondary battery as the source of power for a vehicle is being studied, and there has been an increase of research on development of new materials, new design of a cell and the like.

Conventionally, carbonaceous materials such as graphite have been used as negative electrode materials but recently, metal negative electrode materials have been developed. However, there are still many problems remaining in terms of cycle life, stability and the like.

Carbonaceous materials can be roughly categorized into graphite material with a high crystallinity degree and amorphous carbon material with a low crystallinity degree. Both types, which allow lithium insertion/elimination reaction, can be used as anode active material.

Amorphous carbon material is known that it is available at quick charge and discharge and has a high capacitance while it has a disadvantage of significant cycle deterioration. On the other hand, highly crystalline graphite material has a stable cycle characteristics while its charge characteristics are inferior to those of amorphous carbon material. Currently, graphite materials having stable cycle characteristics are widely used as negative electrode material owing to such factors that the capacitance equivalent to the theoretical capacitance of the battery made from graphite can be attained and the cycle characteristic is stable.

When lithium insertion/elimination reaction on the side of a negative electrode active substance falls behind at the time of quick charge and discharge, the battery voltage rapidly reaches to the lower limit or the upper limit, which stops the further progress of the reaction. The problem occurs notably with respect to highly crystalline graphite material.

The amorphous carbon material is available if only the factor of quick charge and discharge is taken into account. However, the amorphous material is not practical in view of cycle characteristics and the like.

There has been an increase of research on development of composite materials of amorphous materials and highly crystalline graphite materials and the like, which bring together features of both materials, and various techniques have been proposed.

For example, JP-A-2005-285633 (Patent Document 1) discloses the technique of mixing natural graphite and pitch followed by the heat treatment under an inert gas atmosphere at a temperature from 900 to 1100° C. to thereby coat the surface of natural graphite with amorphous carbon (Comparative Example 1 described hereinafter).

Japanese Patent No. 2976299 (Patent Document 2) discloses the technique of dipping the carbonaceous material to be made into the core material in tar or pitch, followed by drying or heat treatment at a temperature from 900 to 1300° C.

Japanese Patent No. 3193342 (Patent Document 3) discloses coating the surface of graphite particles obtained by granulating natural graphite or flaky artificial graphite with a carbon precursor and calcinating it in an inert gas atmosphere at a temperature range of 700 to 2800° C. (Comparative Example 3 described later).

Further, JP-A-2004-210634 (WO2004/056703 pamphlet; Patent Document 4) discloses using composite graphite particles as an anode active material, which is obtained by granulating a flaky graphite having d(002) of 0.3356 nm, R value of around 0.07 and Lc of about 50 nm by use of an external mechanical force to thereby prepare spheroidized graphite particles and coating the particles with a carbide obtained by heating a resin such as phenol resin. The document teaches that the composite graphite particles are obtained by carbonizing in a nitrogen atmosphere preliminarily at 1000° C. and then at 3000° C. (Comparative Example 4 described later).

These conventional graphite materials all exhibit a high battery capacity. However, the cycle characteristics of these materials were insufficient in the cases of Patent Documents 2 to 4. Moreover, charge characteristics in the materials were all low.

Therefore, the present inventors previously proposed composite graphite particles which contains a core material comprising graphite having an interlayer distance (d) for 002 face, d(002) of 0.337 nm or less and a surface layer comprising graphite having the intensity ratio I_{D}/I_{G} (R value) between the peak intensity (I_{D}) in a range of 1300 to 1400 cm⁻¹ and the peak intensity (I_{G}) in a range of 1580 to 1620 cm⁻¹ as measured by Raman spectroscopy spectra of 0.30 or higher, wherein the peak intensity ratio I₁₁₀/I₀₀₄ between the peak intensity (I₁₁₀) of face (110) and the peak intensity (I₀₀₄) of face (004) obtained by XRD measurement on the graphite crystal is 0.15 or higher when the graphite has been mixed with a binder and pressure-molded to a density of 1.55 to 1.65 g/cm³ (WO2007/072858 pamphlet; Patent Document 5), useful for a negative electrode of a secondary battery having high capacitance, good charge-discharge cycle characteristics and further excellent charge characteristic.
[Patent Document 1] Japanese Patent Application Laid-Open No. 2003-142092
[Patent Document 2] Japanese Patent Application Laid-Open No. 2002-237303
[Patent Document 3] Japanese Patent No. 3193342 (European Patent No. 917228)
[Patent Document 4] Japanese Patent Application Laid-Open No. 2004-210634 (WO2004/056703 pamphlet)
[Patent Document 5] WO2007/072858 pamphlet

### DISCLOSURE OF THE INVENTION

### Problems to be Solved by the Invention

An object of the present invention is to provide a composite graphite useful for negative electrode in a lithium secondary battery having better quick charge-discharge characteristics than those of the battery described in Patent Document 5 previously proposed by the present inventors and excellent charge-discharge cycle characteristics, and a paste for negative electrode, a negative electrode and a lithium secondary battery which use the composite graphite.

### Means for Solving the Problem

As a result of studies with a view to achieving the above object, the present inventors have found out that a lithium secondary battery having better quick charge-discharge characteristics than those in Patent Document 5 and good charge-discharge cycle characteristics can be obtained by using as anode active material a composite graphite having higher crystalline orientation (I₁₁₀/I₀₀₄) than in the composite graphite described in Patent Document 5 and comprising a core material consisting of graphite having a specific interlayer distance and a surface layer which is a low-crystallinity carbon whose R value obtained by Raman scattering spectroscopy is a predetermined value or higher. Based on this finding, they have completed the present invention.

That is, the present invention provides composite graphite particles having the following composition and uses thereof.

[1] Composite graphite particles, comprising a core material consisting of graphite having a interlayer distance d(002) of 0.337 nm or less in which the intensity ratio I_{D}/I_{G} (R value) between the peak intensity (I_{D}) in a range of 1300 to 1400 cm⁻¹ and the peak intensity (I_{G}) in a range of 1580 to 1620 cm⁻¹ as measured by Raman spectroscopy spectra is from 0.01 to 0.1 and a carbonaceous surface layer in which the intensity ratio I_{D}/I_{G}(R value) between the peak intensity (I_{D}) in a range of 1300 to 1400 cm⁻¹ and the peak intensity (I_{G}) in a range of 1580 to 1620 cm⁻¹ as measured by Raman scattering spectroscopy is 0.2 or higher.
[2] The composite graphite particles described in 1 above, wherein the peak intensity ratio I₁₁₀/I₀₀₄ between the peak intensity (I₁₁₀) of face (110) and the peak intensity (I₀₀₄) of face (004) obtained by XRD measurement on the graphite crystal is 0.2 or higher when the particles are mixed with a binder and pressure-molded to a density of 1.55 to 1.65 g/cm³.
[3] The composite graphite particles according to 1 or 2 above, comprising vapor-grown carbon fiber attached on the surface layer.
[4] The composite graphite particles according to any one of 1 to 3 above, wherein the crystallite diameter in the c-axis direction Lc of the core material graphite is 50 nm or more.
[5] The composite graphite particles according to any one of 1 to 4 above, wherein the core material graphite is artificial graphite.
[6] The composite graphite particles according to any one of 1 to 5 above, wherein in particle size distribution measurement by laser diffraction method, the average particle size of the core material is within a range of 2 to 40 μm.
[7] The composite graphite particles according to any one of 1 to 6 above, wherein the BET specific surface area is in a range of 0.5 to 6 m²/g.
[8] The composite graphite particles according to any one of 1 to 7 above, wherein the interlayer distance d(002) is 0.337 nm or less and the crystallite diameter in the c-axis direction Lc is 50 nm or more.
[9] The composite graphite particles according to any one of 1 to 8 above, wherein in particle size distribution measurement by laser diffraction method, the average particle size is within a range of 2 to 40 μm.
[10] The composite graphite particles according to any one of 1 to 9 above, wherein the carbonaceous surface layer is obtained by thermally treating an organic compound at a temperature of 500 to 2000° C.
[11] The composite graphite particles according to 10 above, wherein the organic compound is at least one selected from a group consisting of petroleum pitch, coal pitch, phenol resin, polyvinylalcohol resin, furan resin, cellulose resin, polystyrene resin, polyimide resin and epoxy resin.
[12] The composite graphite particles according to 10 or 11 above, wherein the coating amount of the organic compound serving as a raw material for the surface layer graphite is in a range of 0.1 to 10% by mass based on the core material.
[13] A method for producing the composite graphite particles described in any one of 1 to 12 above, comprising a step of mixing an organic compound and the core material consisting of a graphite having an interlayer distance d(002) of 0.337 nm or less and a step of conducting a thermal treatment at a temperature of 500 to 2000° C.
[14] A paste for negative electrode, comprising the composite graphite particles described in any one of 1 to 12 above, a binder and a solvent.
[15] A negative electrode, which is obtained by spreading the paste for negative electrode described in 14 above on a collector, drying and pressure-molding it.
[16] A lithium secondary battery comprising the negative electrode described in 15 above as a constituent.
[17] The lithium secondary battery according to 16 above, using a nonaqueous electrolytic solution and/or nonaqueous polymer electrolyte, wherein the nonaqueous electrolytic solution and/or nonaqueous polymer contains at least one nonqueous solvent selected from a group consisting of ethylene carbonate, diethylene carbonate, dimethyl carbonate, methyl ethyl carbonate, propylene carbonate, butylene carbonate, γ-butyrolactone and vinylene carbonate.

### Effect of the Invention

The composite graphite particles of the present invention realize excellent characteristics at quick charge-discharge and high lithium ion acceptability. Therefore, the present invention is useful as active material for anode active material in a lithium secondary battery having good cycle characteristics, which can be quickly charged.

### BEST MODE FOR CARRYING OUT THE INVENTION

Hereinafter, the present invention will be explained in greater detail.

### (Composite Graphite)

The composite graphite particles of the present invention, which are useful as an anode active material, comprise a core material consisting of graphite and a surface layer consisting of carbonaceous substance.

The graphite used as the core material constituting the composite graphite particles of the present invention has an interlayer distance (d) for 002 face, d(002) of 0.337 nm or less, preferably 0.336 nm or less. A preferred graphite used as the core material has a crystallite diameter in the c-axis direction, Lc of 50 nm or more. These d vale and Lc are measured by powder X-ray diffraction.

The graphite as a core material used in the present invention has the intensity ratio I_{D}/I_{G} (R value) between the peak intensity (I_{D}) in a range of 1300 to 1400 cm⁻¹ and the peak intensity (I_{G}) in a range of 1580 to 1620 cm⁻¹ as measured by Raman spectroscopy spectra of 0.01 to 0.1.

A preferred graphite particle used as the core material has a BET specific surface area of 0.5 to 10 m²/g, preferably 0.5 to 7 m²/g.

Examples of graphite used as the core material include artificial graphite and natural graphite. Preferred is artificial graphite. Materials such as petroleum cokes can be used for the core material.

Furthermore, the artificial graphite is preferably the one subjected to heat treatment at 2000 to 3200° C. The heat treatment is preferably conducted under an inert gas atmosphere, but also can be performed in a conventional Acheson graphitizing furnace.

The composition of the core material and the surface layer can be performed by a known method. For example, graphite powder is pulverized into fine powder at first to obtain a core material. Then the graphite pulverized into fine powder is mixed while spraying a binder and the like to the powder. Various resins such as pitch and phenol resin can be used as the binder, and the amount used is preferably 0.1 to 10 parts by mass to 100 parts by mass of the graphite.

Also, the composition can be performed by having the pitch and phenol resin naturally attached onto the surface of the graphite fine powder while mixing the graphite fine powder, pitch and phenol resin in a device such as a hybridizer produced by Nara Machinery Co., Ltd. and subjecting the mixture to heat treatment.

The average particle size of the core material is preferably from 2 to 40 μm. When there are many fine particles, it is difficult to increase the electrode density. When there are many large-size particles, unevenness in coating is caused at the step of spreading an electrode slurry, which leads to significant deterioration in battery characteristics. In consideration for this, it is preferable that 90% or more of the total graphite particles used as the core material have a particle size of a range of 1 to 50 μm. The particle size of the composite graphite particles of the present invention is almost the same as the particle size of the core material particle size. Even if a surface layer is provided on the particles, the increase in the particle size is within several tens of nanometers at most. It is preferable that the average particle size of the composite graphite particles be in a range of 2 to 40 μm as well.

The surface layer constituting the composite graphite particles of the present invention consists of carbon in which the intensity ratio I_{D}/I_{G}(R value) between the peak intensity (I_{D}) in a range of 1300 to 1400 cm⁻¹ and the peak intensity (I_{G}) in a range of 1580 to 1620 cm¹ as measured by Raman spectroscopy spectra is 0.20 or higher. By providing a surface layer having a large R value, insertion/elimination of ions between graphite layers can become easier, whereby quick charging property of the electrode material for a secondary battery can be improved. Here, the larger the R vale, the lower the crystallinity.

A carbonaceous substance suitable for the surface layer is obtained by polymerizing an organic compound at a temperature of 200 to 2000° C., preferably 500 to 1500° C., more preferably 900 to 1200° C.

When the temperature of the final heat treatment is too low, carbonization ends up incomplete and hydrogen and oxygen remaining in the compound may adversely affect battery characteristics. Therefore, the preferable temperature is 900° C. or higher. If the treating temperature is too high, crystallization of the graphite excessively proceeds, which leads to decrease in battery characteristics. Therefore, the preferable temperature is 1200° C. or less.

There is no limitation on the organic compound. Preferred examples include isotropic pitch, anisotropic pitch, resins, resin precursors and monomers. In a case where a resin precursor or a monomer is used, it is preferable to polymerize the resin precursor or the monomer to prepare a resin. Examples of suitable organic compound include at least one compound selected from the group consisting of phenol resin, polyvinyl alcohol resin, furan resin, cellulose resin, polystyrene resin, polyimide resin and epoxy resin.

It is preferable that the heat treatment be carried out in a nonoxidizing atmosphere. Examples of nonoxidizing atmosphere include an atmosphere filled with an inert gas such as argon gas or nitrogen gas.

Moreover, in the present invention, it is preferable to conduct pulverization after the heat treatment. Since the composite particles are fusion-bonded with each other to thereby form agglomerates during the heat treatment, it is necessary to convert the graphite into fine particles so that it can be used as an electrode active material. With respect to the particle size of the thus microparticulated composite graphite according to the present invention, it is preferable, as described above, that 90% or more of the total particles have a particle size of 5 to 50 μm.

The BET specific surface area of the composite graphite can be in a range of 0.5 to 10 m²/g, preferably 0.5 to 6.0 m²/g.

There is no particular limitation on the proportions of the core material and the surface layer which constitute the composite graphite particles of the present invention. The ratio of the carbonaceous surface layer against the core material is from 0.1 to 10 parts by mass against 100 parts by mass of the core material, in terms of the amount of an organic compound used for obtaining the composite graphite according to the present invention. If the amount of the organic compound is too small, satisfactory effect cannot be achieved. If the amount is too large, the battery capacity may decrease.

The composite graphite particles of the present invention may have vapor-grown carbon fiber attached onto the surface. A preferable average fiber diameter of vapor-grown carbon fiber usable here is in a range of 10 to 500 nm, more preferably 50 to 300 nm, still more preferably 70 to 200 nm, particularly preferably 100 to 180 nm. If the average fiber diameter is less than 10 nm, handleability decreases.

There is no particular limitation on the aspect ratio of vapor-grown carbon fiber. A preferred range of the aspect ratio is from 5 to 1000, more preferably 5 to 500, still more preferably 5 to 300, particularly preferably 5 to 200. If the aspect ratio is 5 or more, it can exhibit the function as a fibrous conductive material and if the aspect ratio is 1000 or less, handleability is good.

Vapor grown carbon fiber can be produced by a process in which an organic compound such as benzene, serving as a raw material, and an organo-transition metallic compound such as ferrocene, serving as a catalyst, are brought together into a high-temperature reaction furnace by using a carrier gas, to thereby cause pyrolysis in vapor phase. Examples of production method include a method in which thermally-decomposed carbon fiber is allowed to generate on a substrate (Japanese Laid-Open Patent Publication (kokai) No. 60-27700); a method in which thermally-decomposed carbon fiber is allowed to generate in floating state (Japanese Laid-Open Patent Publication (kokai) No. 60-54998); and a method in which thermally-decomposed carbon fiber is allowed to grow on the wall of a reaction furnace (Japanese Patent No. 2778434). The vapor-grown carbon fiber used in the present invention may be obtained by using these methods.

The thus-produced vapor-grown carbon fiber as is may be used as a raw material. The vapor grown carbon fiber right after the vapor growth, however, has thermal decomposition products derived from the raw material organic compound attached onto its surface, or its crystallinity of the fiber structure constituting the carbon fiber is unsatisfactory, in some cases. Therefore, for the purpose of removing impurities such as thermal decomposition products or improving the crystallinity for the carbon fiber, thermal treatment may be carried out in an inert gas atmosphere. In a case where impurities such as thermal decomposition products derived from the raw material organic compound are to be removed, it is preferable to conduct heat treatment in an inert gas atmosphere such as argon at a temperature of about 800 to 1500° C. In a case where the crystallinity of the carbon structure is to be improved, it is preferable to conduct heat treatment in an inert gas atmosphere such as argon at a temperature of about 2000 to 3000° C.

On this occasion, a boron compound such as boron carbide (B₄C), boron oxide (B₂O₃), elemental boron, boric acid (H₃BO₃) and borate may be added as a graphitization catalyst. The amount of the boron compound to be added depends on chemical and physical properties of the boron compound and cannot be flatly defined. For example, in a case where boron carbide (B₄C) is used, the preferable amount is in a range of 0.05 to 10% by mass, more preferably 0.1 to 5% by mass, based on the amount of the vapor-grown carbon fiber.

Such a vapor-grown carbon fiber is commercially available, for example, as VGCF (registered trademark, product of SHOWA DENKO K.K.).

There is no particular limitation on the method for attaching (bonding) vapor-grown carbon fiber onto the surface layer. For example, by mixing vapor-grown carbon fiber with the core material and the material of the carbonaceous surface layer and subjecting the mixture to heat treatment during the step of performing composition of the materials, the vapor-grown carbon fiber can be deposited on the surface layer during the process of polymerizing and carbonizing the carbonaceous material of the surface layer in the heat treatment.

A preferred blending amount of the vapor-grown carbon fiber is in a range of 0.1 to 20 parts by mass, more preferably 0.1 to 15 parts by mass, based on 100 parts by mass of the core material. By using 0.1 or more parts by mass of the vapor-grown carbon fiber, the surface of the surface layer can be broadly covered.

The core material and the vapor-grown carbon fiber are connected via electrically conductive carbonaceous surface layer, which lowers the contact resistance and has a major effect compared to the case where the vapor-grown carbon fiber is simply added to the electrode.

In the composite graphite particles of the present invention, the peak intensity ratio I₁₁₀/I₀₀₄ between the peak intensity (I₁₁₀) of face (110) and the peak intensity (I₀₀₄) of face (004) obtained by XRD measurement on the graphite crystal is 0.2 or higher when the graphite has been mixed with a binder and pressure-molded to an electrode density of 1.55 to 1.65 g/cm³.

If this peak intensity ratio is less than 0.2, it degrades charge characteristics. The larger the peak intensity ratio I₁₁₀/I₀₀₄, the lower the crystal orientation in the electrode. The I₁₁₀/I₀₀₄ is preferably 0.3 or more, more preferably 0.4 or more.

In a preferred embodiment of the composite graphite of the present invention, the interlayer distance d(002) is 0.337 nm or less and the crystallite diameter in the c-axis direction (Lc) is 50 nm or more.

### (Paste for Negative Electrode)

The paste for negative electrode of the present invention comprises the above composite graphite, binder and solvent. This paste for negative electrode can be obtained by kneading the above composite graphite, binder and solvent. The paste for negative electrode can be formed into a shape of sheet, pellet or the like.

Examples of binder include polyethylene, polypropylene, ethylenepropylene terpolymer, butadiene rubber, styrene butadiene rubber, butyl rubber, and polymer compounds having a high ion conductivity. Examples of polymer compounds having a high ion conductivity include vinylidene polyfloride, polyethylene oxide, polyepichlorohydrin, polyphosphazen, and polyacrylonitrile. A preferred blending ratio of the binder against the composite graphite is such that the binder is used in a range of 0.5 to 20 parts by mass based on 100 parts my mass of the composite graphite.

There is no particular limitation on the solvent. Examples thereof include N-methyl-2-pyrroridone, dimethylformamide, isopropanol and water. In a case where water is used as a solvent in the binder, it is preferable to use a thickening agent together. The amount of the solvent is adjusted to have a suitable viscosity which makes a step of coating a collector with the paste easy.

### (Negative Electrode)

The negative electrode of the present invention can be obtained by coating a collector with the paste for negative electrode, drying and pressure-molding it.

Examples of collector include foils and meshes of nickel or copper. There is no limitation on the method for coating the collector with the paste. The coating film thickness is generally in a range of 50 to 200 nm. If the thickness is too large, the negative electrode cannot fit a standardized battery vessel, in some cases.

Examples of pressure-molding method include methods using roll-pressure or press-pressure. A preferred pressure at the time of pressure-molding is from about 100 to 300 MPa (about 1 to 3 t/cm²). A negative electrode obtained in this way is suitable for a lithium secondary battery.

### (Lithium Secondary Battery)

The lithium secondary battery of the present invention comprises the negative electrode of the present invention as a constituent.

In the lithium secondary battery of the lithium secondary battery, conventionally-employed materials can be used in the positive electrode. Examples of cathode active material include LiNiO₂, LiCoO₂ and LiMn₂O₄.

There is no limitation on the electrolytic solution used in the lithium secondary battery. Examples thereof include so-called organic electrolytic solutions obtained by dissolving lithium salt such as LiClO₄, LiPF₆, LiAsF₆, LiBF₄, LiSO₃CF₃, CH₃SO₃Li and CF₃SO₃Li in an non-aqueous solvent such as ethylene carbonate, diethyl carbonate, dimethyl carbonate, methylethyl carbonate, propylene carbonate, butylene carbonate, acetonitrile, propylonitrile, dimethoxyethanen, tetrahydrofuran, and γ-butyrolactone, and solid or gelatinous so-called polymer electrolyte.

Also, it is preferable that a small amount of an additive which can show decomposition reaction at the time of the first battery charge be added to the electrolytic solution. Examples of additive include vinylene carbonate, biphenyl, and propane sultone. A preferred addition amount is in a range of 0.01 to 5% by mass.

In the lithium secondary battery of the present invention, a separator may be provided between the positive electrode and the negative electrode. Examples of separator include nonwoven fabric, cloth and macroporous film mainly consisting of polyolefin such as polyethylene and polypropylene and combination of these materials.

### EXAMPLES

Hereinafter, the present invention is explained specifically by way of Examples and Comparative Examples. The present invention, however, is by no means limited by those Examples. With respect to properties of the graphite, the negative electrode and the battery, measurement and evaluations were conducted as follows.

### (1) Specific Surface Area

The specific surface area was measured by BET method.

### (2) Particle Size

Two microspatulafuls of graphite and 2 drops of nonionic surfactant (Triton-X) were added to 50 ml of water and the mixture was subjected to ultrasonic dispersion for 3 minutes. This dispersion liquid was placed into a laser-diffraction particle size analyzer manufactured by CILAS to measure the particle size distribution and work out a particle size range which encompassed 90% or more of the total particles.

### (3) d Value and Lc

The interlayer distance of d(002) and the crystallite diameter in the c-axis direction were determined by powder x-ray diffraction according to Gakushin Method.

### (4) I₀₀₄ and I₁₁₀

KF-polymer manufactured by KUREHA Corporation (L#9210; N-methyl-2-pyrrolidone solution of 10% by mass polyvinylidene difluoride) was added by small portions to graphite and kneaded, so that the solid content of the polyvinylidene difluoride became 5% by mass. Next, by using a non-bubbling kneader (NBK-1) manufactured by NISSEI Corporation, kneading was conducted at 500 rpm for 5 minutes to thereby obtain a paste. By using an automatic coating machine and a doctor blade with a clearance of 250 μm, the obtained paste was spread on a collector.

The collector coated with the paste was placed on a hot plate heated at about 80° C. to thereby remove water content and then dried with a vacuum drier at 120° C. for 6 hours. After drying, the collector was pressure-molded by uniaxial press, so that the electrode density calculated from the total mass of the graphite and the binder divided by the volume became 1.60±0.05 g/cm³, whereby a negative electrode was obtained.

The obtained negative electrode was cut into an appropriate size and attached to a glass cell for XRD measurement. The XRD spectra attributed to (004) face and (110) face were measured. From the respective peak intensities, the peak intensity ratio was calculated.

### (5) Discharge Capacity of Battery

In a glove box whose inside was kept under a dry argon gas atmosphere of dew point −80° C. or less, the following operations were performed.

In a polypropylene-made cell (inner diameter of about 18 mm) having a screw-in lid, the negative electrode was sandwiched between separators (polypropylene-made microporous film (Cell Guard 2400; manufactured by Tonen Corporation)) to thereby form a laminate. Further, with a metal lithium foil (50 μm) for reference, a laminate was formed in the same manner. Electrolytic solution was injected into the above cell and the lid was closed, to thereby obtain a tripolar cell as a test sample. Here, the electrolytic solution had been prepared by dissolving electrolyte LiPF₆ at a concentration of 1 M in a mixed solvent comprising ethylene carbonate and methylethyl carbonate at a volume ratio 2:3.

The obtained tripolar cell was charged at a constant current of 0.2 mA/cm² from the rest potential to 2 mV. Next, the cell was charged at a constant voltage of 2 mV and the charging was terminated at the time point when the current value decreased to 12.0 μA. After the charging, the battery was discharged at a constant current of 0.2 mA/cm² and cut off at a voltage of 1.5 V. The discharge capacity in this charge-discharge was evaluated.

### (6) Cycle Characteristics of Battery

In a glove box whose inside was kept under a dry argon gas atmosphere of dew point −80° C. or less, the following operations were performed.

A positive electrode was prepared by spreading a positive electrode material, c-10, manufactured by NIPPON CHEMICAL WORKS CO., LTD. on an aluminum foil with 3% by mass of a binder (polyvinylidene difluoride: PVDF). In a SUS-made cylindrical jacketing material, a spacer, a plate spring, the above negative electrode and the positive electrode were stacked with a separator (polypropylene-made microporous film “Celguard 2400” manufactured by Tonen Corporation) being present between them. On the laminate body, a cylindrical SUS304-made jacketing material serving as a top lid was placed. Next, this was immersed in an electrolytic solution to thereby conduct vacuum impregnation for 5 minutes. Subsequently, this was sealed by using a coin-cell caulking machine, to thereby obtain a coin-type cell for evaluation.

Using this coin cell, a constant-current constant-voltage charge-discharge test was conducted as follows.

The first and second charge-discharge cycles were conducted in the following manner. The cell was charged at a constant current of 0.2 mA/cm² from the rest potential to 4.2 V. Next, the cell was charged at a constant voltage of 4.2 V and the charging was terminated at the time point when the current value decreased to 25.4 μA. After the charging, the battery was discharged at a constant current of 0.2 mA/cm² and cut off at a voltage of 2.7 V.

The third charge-discharge cycle and cycles thereafter were conducted in the following manner. The cell was charged at a constant current of 1.0 mA/cm² (corresponding to 0.5 C) from the rest potential to 4.2 V. Next, the cell was charged at a constant voltage of 4.2 V and the charging was terminated at the time point when the current value decreased to 25.4 μA. After the charging, the battery was discharged at a constant current of 2.0 mA/cm² (corresponding to 1.0 C) and cut off at a voltage of 2.7 V.

The ratio of the discharge capacity at cycle 3 against the discharge capacity at cycle 100 was evaluated as “cycle capacity-retention rate”.

### (7) Charge Characteristics of Battery (Li Acceptability)

Using the same tripolar cell as used in the above evaluation of discharge capacity, charge characteristics were evaluated.

The cell was charged at a constant current of 0.2 mA/cm² from the rest potential to 2 mV. Next, the cell was charged at a constant voltage of 2 mV and the charging was terminated at the time point when the current value decreased to 12.0 μA. After the charging, the battery was discharged at a constant current of 0.2 mA/cm² and cut off at a voltage of 1.5 V. This charge-discharge operation was conducted twice.

Next, the cell was charged at a constant current of 2 mA/cm² from the rest potential to 2 mV. Next, the cell was charged at a constant voltage of 2 mV and the charging was terminated at the time point when the current value decreased to 12.0 μA. The proportion of the capacity at the constant-current charge in the total charge-capacity was calculated according to the following formula and used in evaluation of charge characteristics.

[Charge capacitance (of constant current charging)/Charge capacitance (of constant current charging+constant voltage charging)]×100(%) [Formula 1]

The larger the proportion, the better the charge characteristics.

### Example 1

Petroleum cokes were used as a material and pulverized into powder having the average particle diameter of 5 μm or less. The powder was subjected to the heat treatment at 3000° C. in an Acheson furnace to obtain the core material having a d value of 0.3359 nm. Isotropic pitch in the form of powder was added thereto in the amount of 1 percent by mass of the core material. Subsequently, heat treatment was conducted under Argon atmosphere at 3000° C. to thereby obtain the composite graphite of the present invention. The evaluation results on this graphite material are shown in Table 1.

### Example 2

Petroleum cokes were used as a material and pulverized into powder having the average particle diameter of 15 μm or less. The powder was subjected to the heat treatment at 3000° C. in an Acheson furnace to obtain the core material having a d value of 0.3359 nm. Isotropic pitch in the form of powder was added thereto in the amount of 1% by mass of the core material. Subsequently, heat treatment was conducted under argon atmosphere at 1100° C. to thereby obtain the composite graphite of the present invention. The evaluation results on the obtained graphite material are shown in Table 1.

### Example 3

Petroleum cokes were used as a material and pulverized into powder having the average particle diameter of 30 μm or less. The powder was subjected to the heat treatment at 3000° C. in an Acheson furnace to obtain the core material having a d value of 0.3359 nm. Isotropic pitch in the form of powder was added thereto in the amount of 1% by mass of the core material. Subsequently, heat treatment was conducted under argon atmosphere at 1100° C. to thereby obtain the composite graphite of the present invention. The evaluation results on the obtained graphite material are shown in Table 1.

### Example 4

Petroleum cokes were used as a material and pulverized into powder having the average particle diameter of 5 μm or less. The powder was subjected to the heat treatment at 3000° C. in an Acheson furnace to obtain the core material having a d value of 0.3359 nm. Isotropic pitch in the form of powder and vapor-grown carbon fiber (VGCF (registered trademark); manufactured by Showa Denko K. K.; average fiber diameter of 150 nm, average aspect ratio of 47) were added thereto in the amount of 1% by mass and 2% by mass of the core material, respectively. Subsequently, heat treatment was conducted under argon atmosphere at 1100° C. to thereby obtain the composite graphite of the present invention. The evaluation results on the obtained graphite material are shown in Table 1.

### Comparative Example 1

According to the disclosure of JP-A-2005-28563, the graphite particles were prepared by the following method.

3 mass % of pulverized petroleum pitch having a softening point of 300° C. was mixed into spheroidized natural graphite produced by Nippon Graphite Industries, ltd. and the mixture was sintered under argon atmosphere at 1000° C. Subsequently, the sintered product was lightly crushed to thereby obtain a graphite material. The evaluation results on the obtained graphite material are shown in Table 1.

### Comparative Example 2

According to the disclosure of the specification of Japanese Patent No. 2976299, the graphite particles were prepared by the following method.

Coal-tar pitch having a softening point of 80° C. was mixed into spheroidized natural graphite produced by Nippon Graphite Industries, ltd. with a ratio of 2 to 1 by mass while being heated to 200° C. The mixture was cooled to room temperature, and then put into hexane at 40° C. and washed while being stirred to remove excessive oil. Then the mixture was separated from hexane by filtration and naturally dried. The resultant was subjected to heat treatment under argon atmosphere at 1000° C. to obtain a graphite material. The evaluation results on this graphite material are shown in Table 1.

### Comparative Example 3

According to description in Japanese Patent No. 3193342, graphite particles were prepared by the following procedures. An artificial graphite, SFG44, was used as raw material and coagulation/spheroidization treatment was conducted by using a hybridizer manufactured by Nara Machinery Co., Ltd. to thereby obtain a sphericity of 0.941. Next, a commercially-available coal-based pitch was added at 15% by mass to the surface of the particles and the mixture was heated to 500° C. while being kneaded. Subsequently, heat treatment was conducted under argon atmosphere at 1500° C. and the resultant was pulverized by using a small-size blender to thereby obtain a graphite material. The evaluation results on the obtained graphite material are shown in Table 1.

### Comparative Example 4

According to description in Japanese Patent Application Laid-Open No. 2004-210604, graphite particles were prepared by the following procedures.

A flaky graphite, SFG44, was used as a raw material and coagulation/spheroidization treatment was conducted by using a hybridizer manufactured by Nara Machinery Co., Ltd.

Methanol solution of 60% by mass phenol resin was added to the powder so as to have 10 mass % solid content of phenol resin, followed by kneading. Then the powder was subjected to heat treatment by heating to 270° C. over five hours and maintaining at 270° C. for two hours. Then, the powder was subjected to heat treatment under nitrogen atmosphere at 1000° C. and under argon atmosphere at 3000° C. to thereby obtain a graphite material. The evaluation results on the obtained graphite material are shown in Table 1.

TABLE 1

| | | | | | | | | | | Battery characteristics | | |
|---|---|---|---|---|---|---|---|---|---|---|---|---|
| | | Surface- | Temperature | Particle properties | | | | | Crystal | | Charge | |
| | | covering | of heat- | Specific | Average | | | | Orien- | Dis- | characteristics | Cycle |
| | | amount | treatment | Surface | Particle | | | | tation | charge | (Li | Capacity- |
| | Core | (mass | after coating | Area | diameter | d(002) | Lc | Raman | I(110)/ | capacity | acceptability) | retention |
| | material | %) | (° C.) | (m²/g) | (μm) | (nm) | (nm) | R value | I(104) | (mAh/g) | (%) | ratio (%) |
| Example 1 | Artificial | 1 | 1100 | 3.0 | 5 | 0.3365 | >100 | 0.77 | 0.40 | 340 | 70 | 78 |
| | graphite | | | | | | | | | | | |
| Example 2 | Artificial | 1 | 1100 | 1.0 | 15 | 0.3364 | 80 | 0.26 | 0.64 | 330 | 65 | 82 |
| | graphite | | | | | | | | | | | |
| Example 3 | Artificial | 1 | 1100 | 1.0 | 30 | 0.3365 | 75 | 0.20 | 0.68 | 330 | 60 | 85 |
| | graphite | | | | | | | | | | | |
| Example 4 | Artificial | 1 | 1100 | 1.2 | 15 | 0.3365 | 80 | 0.32 | 0.65 | 330 | 68 | 88 |
| | graphite | | | | | | | | | | | |
| Comparative | Natural | 3 | 1100 | 3.8 | 22 | 0.3363 | >100 | 0.30 | 0.02 | 362 | 11 | 68 |
| Example 1 | graphite | | | | | | | | | | | |
| Comparative | Natural | 5 | 1300 | 3.2 | 17 | 0.3363 | >100 | 0.28 | 0.02 | 361 | 23 | 70 |
| Example 2 | graphite | | | | | | | | | | | |
| Comparative | Flaky | 15 | 1500 | 3.9 | 20 | 0.3357 | >100 | 0.30 | 0.08 | 360 | 15 | 32 |
| Example 3 | artificial | | | | | | | | | | | |
| | graphite | | | | | | | | | | | |
| Comparative | Flaky | 10 | 3000 | 2.7 | 18 | 0.3357 | >100 | 0.24 | 0.06 | 350 | 18 | 75 |
| Example 4 | artificial | | | | | | | | | | | |
| | graphite | | | | | | | | | | | |

Charge characteristic (lithium acceptability): charge capacity (of constant current charging)/charge capacity (of constant current charging + of constant voltage charging)
Cycle Capacity-retention ratio: the ratio of discharge capacity at cycle 3 against discharge capacity at cycle 100

As seen from the above results, the composite graphite particles of the present invention achieves I₁₁₀/I₀₀₄ of 0.2 or more when the d value of the core material graphite is 0.337 nm or less, the R value of the surface layer graphite is 0.2 or more, and the particles are charged with a binder. The results show that the composite graphite materials having such a property (Examples 1 to 3) have a high initial discharge capacity, a cycle capacity-retention ratio of 78% or more at cycle 100 and charge characteristics (Li acceptability) of 60% or more. Also, with respect to the composite graphite having vapor-grown carbon fiber attached on its surface (Example 4), charge characteristics and cycle capacity-retention ratio are further improved.

On the other hand, as shown in Comparative Examples, although all graphite materials obtained in conventional methods have large discharge capacity, none of the materials obtained good cycle characteristics and charge characteristics (Comparative Examples 1 to 4).

1. Composite graphite particles, comprising a core material consisting of graphite having a interlayer distance d(002) of 0.337 nm or less in which the intensity ratio I_{D}/I_{G} (R value) between the peak intensity (I_{D}) in a range of 1300 to 1400 cm⁻¹ and the peak intensity (I_{G}) in a range of 1580 to 1620 cm⁻¹ as measured by Raman spectroscopy spectra is from 0.01 to 0.1 and a carbonaceous surface layer in which the intensity ratio I_{D}/I_{G} (R value) between the peak intensity (I_{D}) in a range of 1300 to 1400 cm⁻¹ and the peak intensity (I_{G}) in a range of 1580 to 1620 cm⁻¹ as measured by Raman scattering spectroscopy is 0.2 or higher.

2. The composite graphite particles as claimed in claim 1, wherein the peak intensity ratio I₁₁₀/I₀₀₄ between the peak intensity (I₁₁₀) of face (110) and the peak intensity (I_{0 0 4}) of face (004) obtained by XRD measurement on the graphite crystal is 0.2 or higher when the particles are mixed with a binder and pressure-molded to a density of 1.55 to 1.65 g/cm³.

3. The composite graphite particles according to claim 1, comprising vapor-grown carbon fiber attached on the surface layer.

4. The composite graphite particles according to claim 1, wherein the crystallite diameter in the c-axis direction (Lc) of the core material graphite is 50 nm or more.

5. The composite graphite particles according to claim 1, wherein the core material graphite is artificial graphite.

6. The composite graphite particles according to claim 1, wherein in particle size distribution measurement by laser diffraction method, the average particle size of the core material is within a range of 2 to 40 μm.

7. The composite graphite particles according to claim 1, wherein the BET specific surface area is in a range of 0.5 to 6 m²/g.

8. The composite graphite particles according to claim 1, wherein the interlayer distance d(002) is 0.337 nm or less and the crystallite diameter in the c-axis direction (Lc) is 50 nm or more.

9. The composite graphite particles according to claim 1, wherein in particle size distribution measurement by laser diffraction method, the average particle size is within a range of 2 to 40 μm.

10. The composite graphite particles according to claim 1, wherein the carbonaceous surface layer is obtained by thermally treating an organic compound at a temperature of 500 to 2000° C.

11. The composite graphite particles according to claim 10, wherein the organic compound is at least one selected from a group consisting of petroleum pitch, coal pitch, phenol resin, polyvinylalcohol resin, furan resin, cellulose resin, polystyrene resin, polyimide resin and epoxy resin.

12. The composite graphite particles according to claim 10, wherein the coating amount of the organic compound serving as raw material for the surface layer graphite is in a range of 0.1 to 10% by mass based on the core material.

13. A method for producing the composite graphite particles claimed in claim 1, comprising a step of mixing an organic compound and the core material consisting of a graphite having an interlayer distance d(002) of 0.337 nm or less and a step of conducting a thermal treatment at a temperature of 500 to 2000° C.

14. A paste for negative electrode, comprising the composite graphite particles claimed in claim 1, a binder and a solvent.

15. A negative electrode, which is obtained by spreading the paste for negative electrode claimed in claim 14 on a collector, drying and pressure-molding it.

16. A lithium secondary battery comprising the negative electrode claimed in claim 15 as a constituent.

17. The lithium secondary battery according to claim 16, using a nonaqueous electrolytic solution and/or nonaqueous polymer electrolyte, wherein the nonaqueous electrolytic solution and/or nonaqueous polymer contains at least one nonqueous solvent selected from a group consisting of ethylene carbonate, diethyl carbonate, dimethyl carbonate, methyl ethyl carbonate, propylene carbonate, butylene carbonate, γ-butyrolactone and vinylene carbonate.
